(19) United States
(12) Patent Application Publication
(10) Pub. No.: US 2014/0093660 A1
(43) Pub. Date: Apr. 3, 2014

(54) METHOD FOR MANUFACTURING BIPOLAR PLATE

(71) Applicant: INDUSTRIAL TECHNOLOGY RESEARCH INSTITUTE, Hsinchu (TW)

(72) Inventors: Chun-Han Li, Tainan (TW); Chien-Jung Huang, Tainan (TW); Sung-Ho Liu, Kaohsiung (TW)

(73) Assignee: INDUSTRIAL TECHNOLOGY RESEARCH INSTITUTE, Hsinchu (TW)

(21) Appl. No.: 13/712,394

(22) Filed: Dec. 12, 2012

(30) Foreign Application Priority Data
Oct. 3, 2012 (TW) 101136582

(51) Int. Cl. B05D 3/06

(52) U.S. Cl. CPC B05D 3/06
USPC 427/596

(57) ABSTRACT

A method for manufacturing bipolar plate includes placing a mixed material on a plate wherein the mixed material includes a carbon material as well as a resin and the material of the plate is metal, and irradiating a light to the mixed material for modifying the mixed material wherein the light is a laser light.

### CROSS-REFERENCE TO RELATED APPLICATIONS

This non-provisional application claims priority under 35 U.S.C. §119(a) on Patent Application No(s). 101136582 filed in Taiwan, R.O.C. on Oct. 3, 2012, the entire contents of which are hereby incorporated by reference.

### BACKGROUND

1. Technical Field

The disclosure relates to a method for bipolar plate manufacturing, and more particularly, to a method for manufacturing bipolar plate using composite material.

2. Related Art

Activities of human beings generally need to consume energy. For getting the necessary energy to consume, people started burning substances such as coal, oil and gas to convert their inherent chemical energy to heat and steam the water so that the steam could be used to move objects or further converted to electricity, i.e., steam turbine. Later, people enable gas produced by burning substances to move objects, i.e., an automobile engine. However, the energy conversion efficiency of the burning of the substance (the chemical energy) to either kinetic energy or electricity is low since a significant amount of the chemical energy becomes heat during the process.

Therefore, scholars started to find alternatives to the aforementioned process for converting the chemical energy directly into electricity (or electrical energy) by skipping the conversion of the chemical energy to the kinetic energy. For example, a fuel cell is developed to utilize the energy difference in the chemical energy and transmission of protons in an electrolyte to release the corresponding electrical energy in the fuel cell. In doing so, the fuel cell could convert most of its chemical energy into electrical energy. However, the electrolyte in the fuel cell contains some ions such as nitrate ions and the fuel cell operates in a high temperature environment, a bipolar plate made of metals is subject to corrosion more easily despite the good conductivity. Moreover, the conductivity could be further affected because of the forming of the passivation layer on the corroded metal of the bipolar plate, which could have a negative impact on the efficiency of the fuel cell or even have the same damage. If the bipolar plate is made of, carbon material, although with better anti-corrosion property, the ductility is weaker such that the bipolar plate may not be made thinner with better mechanical strength. Therefore, a bipolar plate having a metal plate as its substrate and a carbon layer coated on the substrate was developed.

One conventional method for manufacturing the bipolar plate includes coating carbon material on a metal plate before sticking the carbon layer on the metal plate by thermo compression. However, the carbon layer manufactured in the process, which is generally no less than 200 micron meters in thickness, thereby affecting weight reducing of the fuel cell and energy conversion efficiency.

Another conventional method for manufacturing the bipolar plate includes placing the metal plate with the coated carbon material in a vacuum oven at high temperature for carbon pyrolysis. Such method could result in a thin carbon layer, the metal plate may deform easier because of the high temperature environment, which further enables the rupture of the carbon layer. Moreover, in order to avoid the combustion the carbon with oxygen at the high temperature, the oven needs to be kept in a vacuum condition or filled with an inert gas. Plus, this manufacturing method takes up to 12 hours to prepare a 20 centimeter length by 20-centimeter width bipolar plate, which significantly increases the manufacturing costs of the bipolar plate.

Therefore, providing alternatives to the conventional approaches for manufacturing a relatively thinner bipolar plate that is better in conductivity and anti-corrosion capability, without incurring too much unnecessary cost, may be necessary.

### SUMMARY

An embodiment discloses a method for manufacturing a bipolar plate comprising providing a mixed material having a carbon material and a resin on a metal plate, and irradiating a laser light to the mixed material for modifying the mixed material.

### BRIEF DESCRIPTION OF THE DRAWINGS

The disclosure will become more fully understood from the detailed description given herein below for illustration only, and thus are not limitative of the disclosure, and wherein:

FIG. 1 is a schematic diagram of a bipolar plate manufacturing system according to one embodiment of the disclosure;

FIG. 2 is a flow chart of a method for manufacturing a bipolar plate according to one embodiment of the disclosure;

FIG. 3A is a Raman Spectroscopy diagram for the mixed material before the modifications according to one embodiment of the disclosure;

FIG. 3B is a Raman Spectroscopy diagram for the mixed material after the modifications according to one embodiment of the disclosure; and

FIG. 4 is a diagram of Tafel corrosion tests for the mixed material before and after the modifications according to one embodiment of the disclosure.

### DETAILED DESCRIPTION

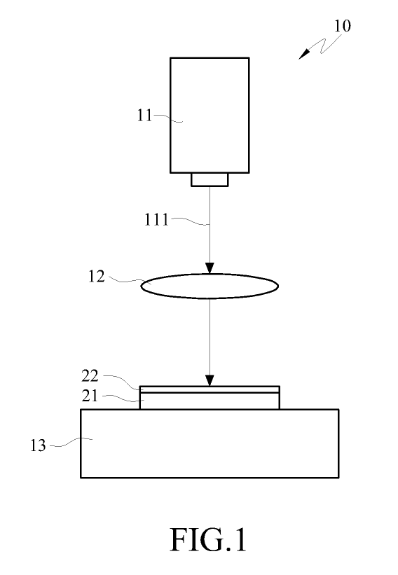

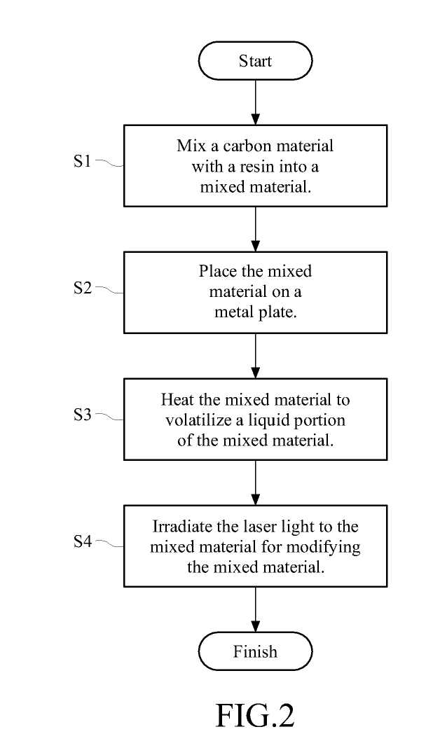

Please refer to FIG. 1, which is a schematic diagram of a bipolar plate manufacturing system 10 according to one embodiment of the disclosure. The bipolar plate manufacturing system 10 comprises a laser source 11, a focusing lens 12, and a working table 13. Please refer to FIG. 1 and FIG. 2. FIG. 2 is a flow chart of a method for manufacturing a bipolar plate according to one embodiment of the disclosure.

The method shown in FIG. 2 includes mixing carbon material with resin into mixed material 22 (step S1). In one embodiment, the carbon material is selected from a group consisting of spherical graphite, flake graphite, graphene, carbon nanotubes, and combinations thereof, while the resin may be carbon-containing resin. The resin, for example, may be selected from the group consisting of phenolic resin, epoxy resin, or combinations thereof The weight percentage of the carbon in the mixed material 22 may range from 20%-80%.

In step S2, the method includes placing the mixed material 22 on a metal plate 21. In one embodiment, the thickness of the mixed material 22 disposed on the metal plate 21 may be less than 200 micro meters. In another embodiment, the thickness of the mixed material 22 may be formed to be less than 150 micro meters. The material of the metal plate 21, for example, may be selected from the group consisting of stainless steel, aluminum, copper, nickel and combinations thereof. The thickness of the metal plate 21 may be less than 0.5 mm. The mixed material 22 may be disposed on the metal plate 21 by coating. The coating may be performed in a form selected from the group consisting of the thermo-compression coating, spin coating, immersion coating, spray coating and roll coating. Moreover, when the weight percentage of the carbon in the mixed material 22 is lowered, the mixed material 22 is more easily coated on the metal plate 21 with a lesser thickness.

In step S3, the method includes heating the mixed material 22 to volatilize the liquid portion of the mixed material 22 as well as placing the metal plate 21 and the mixed material on the working table 13. In this embodiment, the temperature for heating the mixed material 22 may be around or less than the boiling point of the liquid portion in the material 22. When the liquid portion of the mixed material 22 is water or acetone, the heating temperature is about 100 degrees Celsius, and heating time may last for around one minute.

In step S4, the laser source 11 emits a laser light 111, which is focused by the focusing lens 12 before the focused laser light 111 irradiates the mixed material 22 for modifying the mixed material 22 so that a part of the mixed material 22 may become a glassy carbon structure. The laser light 111 provides the mixed material 22 with the energy density of 0.05 to 1200 joules per square centimeter. When the weight percentage of the carbon in the mixed material 22 is increased, generally the required energy density, provided by the laser light 111, becomes lower. In this embodiment, the wavelength of the laser light 111 may be less than 100,000 nanometers, and the laser source 11 may be implemented in the form of an infrared laser generating means. In this embodiment, the modification process of the mixed material 22 whose size is 20-centimeter length and 20-centimeter width may take less than two minutes to complete. In one embodiment, the modification process of the mixed material 22 may not need to be performed in a vacuum environment. In other words, the modification process may be performed in an air environment. The modification process of the mixed material 22 may be repeatedly performed, with the energy density provided in each of the modifications may not to deform the metal plate. Furthermore, when the number of times of the modification process is increased, the glassy carbon structure becomes denser.

Despite the relatively lower conductivity of the resin material, the mixed material 22 having the resin material may be therefore disposed on the metal plate with the thickness less than 200 micrometers, or even less than 150 micrometers. Upon being irradiated by the laser light 111, chemical bonds between non-carbon elements and carbon elements in the resin may be broken, which causes the carbon elements in the carbon material and the carbon elements in the resin to re-form a chemical bond, with other elements such as hydrogen, oxygen, sulfur, nitrogen and other elements escaping to the surrounding atmosphere. When the carbon elements bond together in an SP2 orbital, formed carbon composition may be close to resemble the graphite in characteristic. Otherwise, when carbon elements bond together in an SP3 orbital, the formed carbon composition may resemble a diamond in characteristic. Both the graphite and the diamond may become the glassy carbon structure on the metal plate. Therefore, when the modification is carried out with the laser light 111, the carbon elements that are in the form of graphite and diamond in the mixed material 22 may increase, which enhances the conductivity of the mixed material 22.

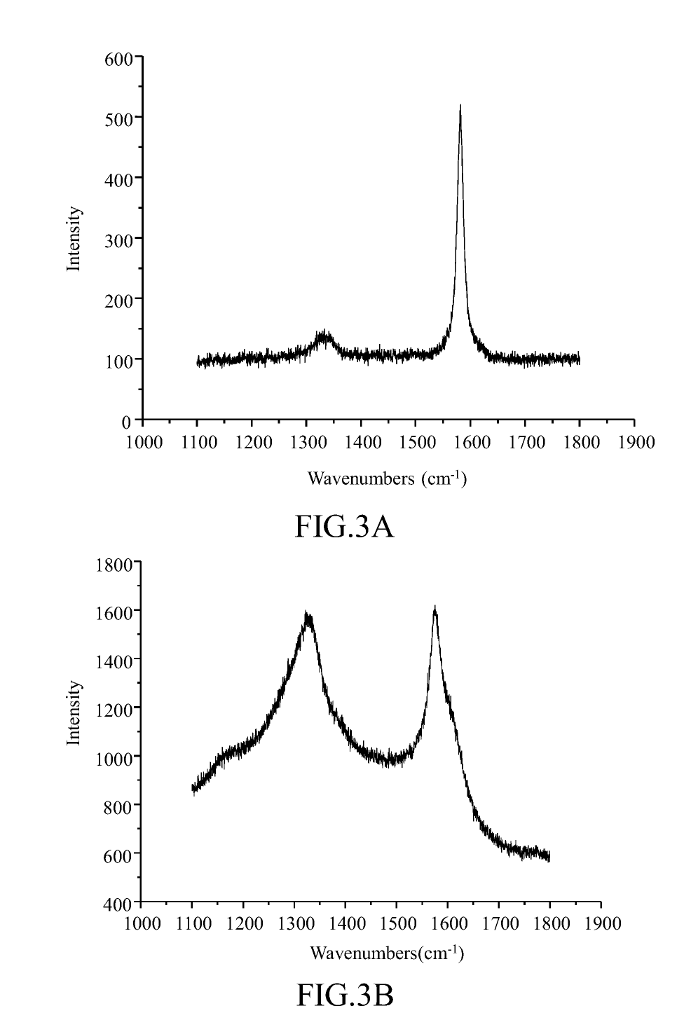

Please refer to FIGS. 3A and 3B, which illustrate Raman Spectroscopy diagrams for the mixed material before and after the aforementioned modifications. If the mixed material 22 has the graphite-based carbon, the intensity in the above diagram may peak at the wave number of approximately 1580 cm⁻¹. The wave number refers to the number of the waves per centimeter. If the mixed material 22 has the diamond-based carbon, the intensity may peak at the wave number around 1332 cm⁻¹. The smaller wave number may correspond to the larger wavelength. Also, the larger intensity in the diagram may correspond to the larger quantity in the corresponding composition. And the intensity in the diagram indicates ratios between the mixed material and its various components. As shown in FIG. 3A, prior to the modifications, the relative intensity of the graphite-based carbon of the mixed material 22 is about 520 units while the relative intensity of the diamond-based carbon is about 150 units in the intensity. After modifications, as shown in FIG. 3B, the relative intensity of graphite-based carbon and that of the diamond-based carbon are both approximately 1600 units. In other words, the proportion of the graphite-based carbon of the mixed material 22 is tripled after the modifications. Furthermore, the proportion of the diamond-based carbon of the mixed material 22 after the modifications is even ten times greater than before. Compared to the resin, the electrical conductivity of the graphite and that of the diamond are greater than that of the resin. Therefore, when the proportion of the graphite-based carbon and the diamond-based carbon of the mixed material 22 is increased, the electrical conductivity of the mixed material 22 is enhanced, which improving the electrical conductivity of the bipolar plate having the metal plate 21 and the mixed material 22 accordingly.

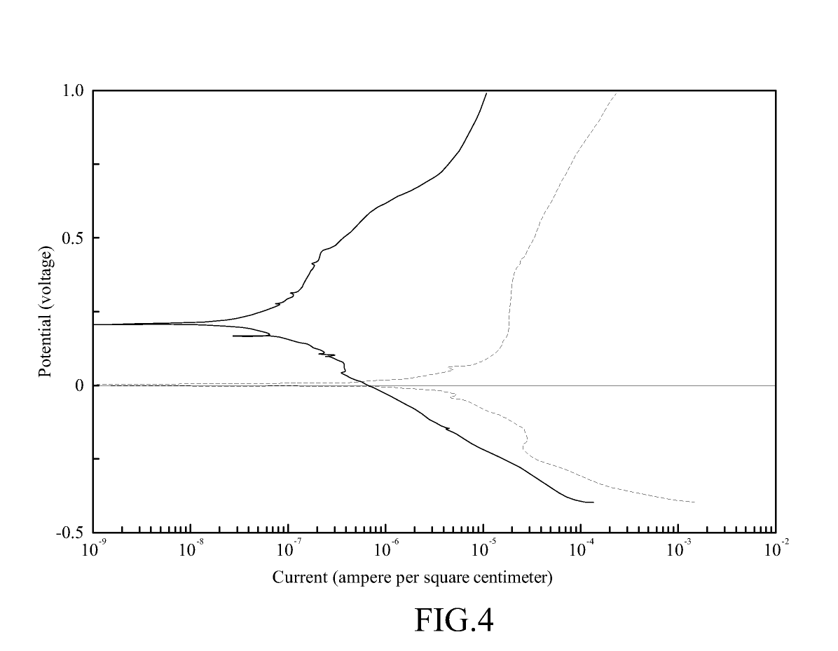

Please refer to FIG. 4, which is a diagram of Tafel corrosion tests for the mixed material 22 before and after the modifications according to one embodiment of the disclosure. A first bipolar plate includes the pre-modified mixed material 22 and the metal plate 21, and a second plate includes the post-modified mixed material 22 and the metal plate 21. In the Tafel corrosion tests, both the first bipolar plate and the second bipolar plate are tested by either a constant-voltage testing method or a dynamically-changing-voltage method in order to obtain anode polarization curves having approximately positive slopes and cathode polarization curves having approximately negative slopes according to changes in voltages and currents. Moreover, the intersection of the two polarization curves corresponds to the voltage and the current where the potential corrosion on the material may take place. A larger corrosion voltage and a lower corrosion current may indicate that such material is less susceptible to the corrosion. As shown in FIG. 4, the dotted lines indicate the anode and the cathode polarization curves of the first bipolar plate where the solid lines indicate the anode and the cathode polarization curves of the second bipolar plate. The corrosion voltage of the first bipolar plate is approximately 0 volt and the corrosion current is 5.1×10⁻⁶ amperes per square centimeter, and furthermore the corrosion voltage of the second bipolar plate is around 0.2 volts and the corrosion current being 2.9×10⁻⁸ amperes per square centimeter. In summary, the second bipolar plate is associated with the larger corrosion voltage and lower corrosion current. Therefore, it is less susceptible to corrosion.

In summary, the mixed material of the disclosure is not disposed on the metal plate just through the thermo-compression method. Rather, the mixed material of the disclosure is modified first, so that the mixed material could be placed on the metal plate in the thickness of less than 200 micro meters or even less than 150 micro meters, thereby reducing the thickness and weight of the bipolar plate. Plus, the mixed material that is modified by the laser light may be superior in conductivity and anti-corrosion capability. Meanwhile, the bipolar plate using the mixed material of the disclosure may eliminate the necessity of the high temperature and vacuum manufacturing process. Therefore, the manufacturing expenses are reduced and the manufacturing time is shortened.

What is claimed is:

1. A method for manufacturing bipolar plate, comprising:
placing a mixed material on a metal plate, wherein the mixed material comprises a carbon material and a resin; and
irradiating a laser light to the mixed material for modifying the mixed material.

2. The method according to claim 1, wherein the carbon material is selected from a group consisting of spherical graphite, flake graphite, graphene, carbon nanotubes and combinations thereof.

3. The method according to claim 1, wherein the resin is a carbonaceous resin.

4. The method according to claim 1, wherein the resin material is selected from a group consisting of phenolic resins, epoxy resins, and combinations thereof

5. The method according to claim 1, wherein the metal plate is made of a material selected from a group consisting of stainless steel, aluminum, copper, nickel, and combinations thereof

6. The method according to claim 1, wherein the metal plate is less than 0.5 mm in thickness.

7. The method according to claim 1, wherein the carbon material is 20 to 80 weight percentage of the mixed material.

8. The method according to claim 1, wherein the mixed material is less than 200 micron meters in thickness.

9. The method according to claim 1, wherein the mixed material is placed on the metal plate by coating.

10. The method according to claim 9, wherein the coating way is selected from a group consisting of a thermo-compression coating, spin coating, immersion coating, spray coating and roll coating.

11. The method according to claim 1, prior to irradiating, further comprising heating the mixed material to volatilize a liquid portion of the mixed material.

12. The method according to claim 1, wherein an energy density per square centimeter for irradiating the laser light to the mixed material ranges from 0.05 to 1200 joules.

13. The method according to claim 1, wherein the wavelength of the laser light is less than 100,000 nanometers.
